(19) United States
(12) Patent Application Publication
(10) Pub. No.: US 2021/0216389 A1
(43) Pub. Date: Jul. 15, 2021

(54) AUTOMATIC REPAIRS VIA COMMUNICATIONS WITH PEER DEVICES ACROSS MULTIPLE NETWORKS

(71) Applicant: Hewlett-Packard Development Company, L.P., Spring, TX (US)

(72) Inventors: Leonardo Rodriguez Heredia, Porto Alegre (BR); Augusto Queiroz de Macedo, Porto Alegre (BR); Marina Rizzotto Pasquali, Porto Alegre (BR); Carlos Silvano Valvassori, Porto Alegre (BR)

(73) Assignee: Hewlett-Packard Development Company, L.P., Spring, TX (US)

(21) Appl. No.: 17/048,165

(22) PCT Filed: Oct. 2, 2018
(86) PCT No.: PCT/US2018/053870

§ 371 Date: Oct. 16, 2020

(51) Int. Cl. G06F 11/07; G06F 21/44

(52) U.S. Cl. CPC G06F 11/079; G06F 21/44; G06F 11/0721; G06F 11/0769

(57) ABSTRACT

An example of an apparatus including a memory storage unit to store a local set of troubleshooting solutions. The apparatus further an administration engine to communicate with a first network. The administration engine is to manage a service subscription. The apparatus also includes a communication interface to communicate with a peer device. The peer device is part of a second network separate from the first network. The apparatus also includes an authentication engine to authenticate the peer device to establish a link with the peer device to access a peer set of troubleshooting solutions. In addition, the apparatus includes a diagnostic engine to collect diagnostic data to identify an issue. The diagnostic engine selects a solution from the local set of troubleshooting solutions and the peer set of troubleshooting solutions based on the diagnostic data. The apparatus includes a repair engine to implement the solution.

### BACKGROUND

Various devices and apparatus decrease in performance as the device ages. The degradation may be caused by physical aging of parts or components. In such cases, parts or components may be replaced to restore the performance of a device. The degradation may also be caused by software issues. As devices are used, various applications may be installed on each device to carry out tasks. Devices may operate many multiple applications simultaneously. Therefore, each device may allocate resources in order to allow the applications to properly function. Since each application may use a different amount of resources, some applications will use more resources than others which may slow the device.

### BRIEF DESCRIPTION OF THE DRAWINGS

Reference will now be made, by way of example only, to the accompanying drawings in which:

FIG. 1 is a block diagram of an example apparatus to carry out automatic repairs using communications with peer devices across multiple networks;

FIG. 2 is a block diagram of an example peer device to carry out automatic repairs using communications with peer devices across multiple networks;

FIG. 3 is a representation of an example system having multiple networks to carry out automatic repairs using communications with peer devices across multiple networks;

FIG. 4 is a flowchart of an example method of carrying out automatic repairs using communications with peer devices across multiple networks; and

FIG. 5 is a block diagram of another example apparatus to carry out automatic repairs using communications with peer devices across multiple networks.

### DETAILED DESCRIPTION

Devices connected to a network may be widely accepted and may often be more convenient to use. In particular, new services have developed to provide devices as a service where a consumer simply uses the device while a service provider maintains the device and ensures that its performance is maintained at a certain level.

With repeated use of any device over time, the device uses various parts or components that may wear down over time and eventually fail. In addition, overall performance of the device may also degrade over time. The overall performance degradation of the device may be a combination of software performance degradation and hardware performance degradation. While measuring the overall performance of the device may be relatively easy, such as measuring processor capacity use or memory use, attributing the cause of a decrease in overall performance to either a software performance issue or a hardware performance issue may call for substantial additional testing. In particular, changing applications on a device may be a cause for degradation of the overall performance over time on a device. The specific cause of the performance degradation may also not be readily identifiable. Therefore, troubleshooting the issue may involve significant amounts of time from a technical support representative.

To reduce the number of calls to and/or to increase the efficiency of addressing issues involving a technical support center, a network of devices may be used to diagnose and automatically implement a solution to an issue on a device. The network of devices provides a web of knowledge that may be shared among devices. In some examples, the devices on a specific network, such as a device as a service client, may share knowledge across multiple networks, such as networks for other clients of the device as a service offering. It is to be appreciated that when sharing knowledge across different networks, security concerns may arise since confidential data is to be secured while a device external to the network queries for a troubleshooting solution.

In the present examples, a device that detects an issue may perform an internal query to a local set of troubleshooting solutions to determine if there are any known solutions to the detected issue. If no solution is found with the local set of troubleshooting solutions, the device may query other authorized devices to search the other device's set of troubleshooting solutions. If a solution is found on another device, the solution may be downloaded and used on the initial device to resolve the issue. In some examples, once a solution successfully addresses the issue, the solution is added to the local set of troubleshooting solutions to increase the web of knowledge of solutions.

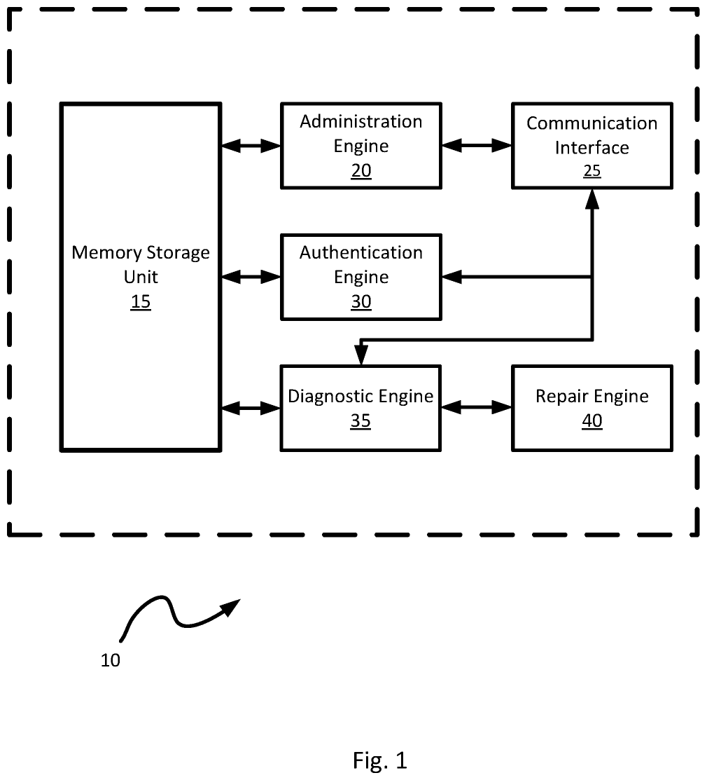

Referring to FIG. 1, an example of an apparatus to carry out automatic repairs using communications with peer devices across multiple networks is generally shown at 10. The apparatus 10 may include additional components, such as various interfaces to communicate with other devices, and further input and output devices to interact with an administrator with access to the apparatus 10. In the present example, the apparatus 10 includes a memory storage unit 15, an administration engine 20, a communications interface 25, and an authentication engine 30, a diagnostic engine 35, and a repair engine 40. Although the present example shows the administration engine 20, the authentication engine 30, the diagnostic engine 35, and the repair engine 40 as separate components, in other examples, the administration engine 20, the authentication engine 30, the diagnostic engine 35, and the repair engine 40 may be part of the same physical component such as a microprocessor configured to carry out multiple functions, or combined in a plurality of microprocessors.

The memory storage unit 15 is to store a local set of troubleshooting solutions. The manner by which the memory storage unit 15 stores the local set of troubleshooting solutions is not particularly limited. In the present example, the memory storage unit 15 may maintain a table in a database to store a local set of troubleshooting solutions as issue/solution pairs, such as in a pair of columns where the first column represents known issues and the second column represents a successful solution that was implemented in the past. In other examples, the local set of troubleshooting solutions may be stored using other database structures, such a relational database for storing additional information, such as historical data related to the historical success rate of solutions.

In the present example, the memory storage unit 15 may include a non-transitory machine-readable storage medium that may be, for example, an electronic, magnetic, optical, or other physical storage device. In the present example, the memory storage unit 15 is a persistent memory for storing the local set of troubleshooting solutions. It is to be appreciated that the memory storage unit 15 may not be exclusively used for storing the local set of troubleshooting solutions and that other data may also be stored on the memory storage unit 15. For example, the local set of troubleshooting solutions may be stored in a separate directory or partition from other data. Other data that the memory storage unit 15 may include an operating system that is executable by a processor to provide general functionality to the apparatus 10. For example, the operating system may provide functionality to additional applications. Examples of operating systems include Windows™, macOS™, iOS™, Android™, Linux™, and Unix™. The memory storage unit 15 may additionally store instructions to operate at the driver level as well as other hardware drivers to communicate with other components and peripheral devices of the apparatus 10.

The administration engine 20 is to communicate with a network to manage a subscription service. In the present example, the subscription service may be for a device as a service, where the administration engine 20 is to manage aspects of the subscription service based on a role of the apparatus. For example, if the apparatus 10 is designated as an administrator apparatus, the administration engine 20 may be authorized to carry out several administrative roles associated with the subscription service. For example, the administration engine 20 may add and remove other devices from the network as well as set permissions of other devices and/or assign roles to the other devices on the network within the conditions outlined in the subscription service. The conditions of the subscription service are not particularly limited and may vary between each subscription. In general, a subscription service may be associated with a company contracting a third party to provide devices as a service. The subscription service may also include various options that provide varying levels of control and management for the company which is set prior to the start of the subscription service.

In addition, the administration engine 20 may also establish partnerships with another network associated with another subscription service where data may be exchanged between devices on both networks. It is to be appreciated that when data is permitted to be exchanged between networks, the administration engine 20 may manage confidential data between networks such that confidential data is not exchanged between networks. Accordingly, the partner networks may form a distributed set of networks to share information for troubleshooting devices without the intervention from a customer service representative.

In another example, the apparatus 10 may be designated as a standard device on a network. In this example, the administration engine 20 may be authorized to manage data during normal operations on the network. The functions of the administration engine 20 may be limited from an apparatus designated as an administrator device. The limits may be set by administrator device and may vary depending on the subscription service as well as the policies set by each organization. For example, the administration engine 20 may be permitted to add additional devices to the subscription service in the same role or a more restricted role. However, the administration engine 20 may be restricted from establishing partnerships for sharing data with external networks.

In a further example, the apparatus 10 may be designated as a guest device on a network. In this example, the administration engine 20 may be limited from carrying out any functions on the network. Instead, the administration engine 20 may be limited to managing local data and to managing requests for data from other devices.

The designation of the role of the apparatus 10 is not particularly limited. As discussed above, the role may be assigned by an apparatus 10 in an administrator role. In other examples, the role may be set by the service provider when distributing devices at the beginning of a device as a service subscription. In the present example, the role of the apparatus 10 may be stored in the memory storage unit 15 along with other device information.

The communications interface 25 is to communicate with a peer device connected to a separate network from the apparatus 10. For example, if the apparatus 10 is connected to a network of Company A and is part of a devices as a service subscription, the peer device may be part of a network of Company B which may have a different service subscription from the apparatus 10. In particular, the apparatus 10 and the peer device may be client devices of a different device as a service systems that are part of a partnership to share data relating to troubleshooting solutions.

The manner by which the communications interface 25 receives data is not particularly limited. In the present example, the apparatus 10 may connect to the peer device via a peer-to-peer link. Accordingly, the communications interface 25 may be a network interface communicating over the internet in this example. In other examples, the communication interface 25 may connect to the devices via a wire or other direct link connecting the apparatus 10 and the peer device.

In the present example, the data exchanged is not particularly limited. For example, the data may include issue/solution pairs for troubleshooting issues at the apparatus 10. The data may also include a description of the issue or an error code collected using a background process carried out by a diagnostic engine 35 and sent to the peer device.

The authentication engine 30 is to authenticate a peer device to establish a link with the peer device. In the present example, the authentication engine 30 is to provide a security layer when seeking troubleshooting solutions from the peer device which is part an external network and not part of the network to which the apparatus 10 is connected. It is to be appreciated that issues with the apparatus 10 may not be sent to a peer device unless the peer device is part of a partnership and has sufficient security clearance to obtain knowledge about the overall health of the apparatus 10. Similarly, when the apparatus 10 operates as a peer device to another device from an external network, the authentication engine 30 may be used to authenticate the device on the external network so that troubleshooting solutions are provided to partner networks instead of to an unknown network or a competitor network.

The diagnostic engine 35 is to carry out a diagnostic process on the apparatus 10. In the present example, the diagnostic engine 35 periodically carries out the diagnostic process. In other examples, the diagnostic engine 35 may carry out the diagnostic process upon receiving a request from a user or other source via the communication interface 25. In the present example, the diagnostic engine 35 is to collect diagnostic data using the diagnostic process on various components of the apparatus 10, such as the memory storage unit 15 and/or a processor, to identify a potential issue.

In the present example, the diagnostic engine 35 is to collect diagnostic data from a processor and the memory storage unit 15 of the apparatus 10. The diagnostic engine 35 operates as a background process during normal operation of the apparatus 10 to collect the diagnostic data. The background process may use a small amount of processor resources such that the background process does not substantially affect foreground processes running on the apparatus 10. The diagnostic data may be evaluated by the diagnostic engine 35 to determine if the apparatus 10 has an issue that is to be corrected. In the present example, the evaluation process may occur automatically at regular intervals. For example, the diagnostic engine 35 may evaluate the diagnostic data to identify issues every 15 minutes. In other examples, the diagnostic engine 35 may evaluate the diagnostic data every hour or less frequently, such as once a day. In further examples, the evaluation process may occur continuously in the background while other processes are carried out in the foreground.

Upon the identification of an issue with the apparatus 10, the diagnostic engine 35 may search the memory storage unit 15 for a solution from the local set of troubleshooting solutions. In addition, the diagnostic engine 35 may also submit a query to the peer device which was authenticated by the authentication engine 30. In return, the peer device may provide a set of troubleshooting solutions. The manner by which the diagnostic engine 35 selects a troubleshooting solution is not particularly limited. For example, the diagnostic engine 35 may search the local set of troubleshooting solutions first and upon failing to find a suitable solution to the issue, the diagnostic engine 35 may then submit a query to the peer device. In other examples, the diagnostic engine 35 may submit queries to obtain additional solutions to an issue and subsequently select a solution from multiple sources that may be suitable for the identified issue.

The repair engine 40 is to implement the solution selected by the diagnostic engine 35. The manner by which the repair engine 40 implements the solution is not particularly limited an may depend on the issue/solution identified by the diagnostic engine 35. For example, if the diagnostic engine 35 classified an issue as a hardware issue, the repair engine 40 may generate a message on a display for a user to take action to replace a hardware component. In another example, the repair engine 40 may transmit a message to an administrator, such as the administrator of a device as a service subscription, that the apparatus 10 is experiencing a hardware failure to be corrected. If the diagnostic engine 35 classifies the issue as a software issue, the solution selected may involve the repair engine 40 initiating a process to correct the software issue. For example, the software issue may be identified by the diagnostic engine 35 to be an error associated with a driver that is to be updated. In this case, the repair engine 35 may automatically update the driver. As another example, the issue may involve a software update that causes unexpected compatibility issues with the existing hardware or software of the apparatus 10. In this case, the repair engine 40 may roll back the update.

It is to be appreciated that in some examples, the repair engine 40 may also evaluate the success of the implemented solution. The manner by which success is measured is not limited. For example, the same data collected by the diagnostic engine 35 may be evaluated to determine if the issue has been resolved. In some examples, a successful solution selected from a set of solutions received from a peer device may be added to the local set of troubleshooting solutions on the memory storage unit 15 to make it available in the future to the apparatus 10 or to other devices that query the apparatus 10.

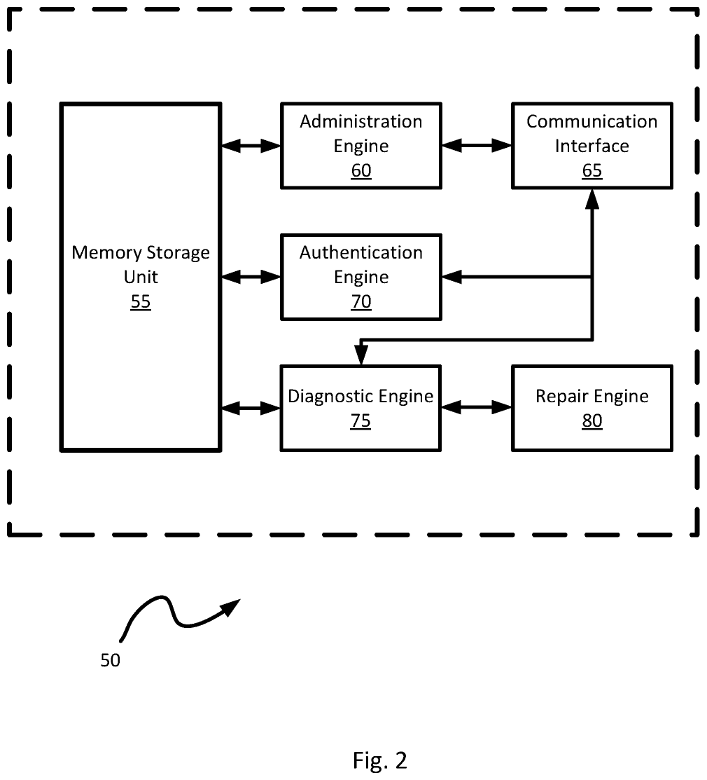

Referring to FIG. 2, an example of a peer device to work in cooperation with the apparatus to carry out automatic repairs using communications with across multiple networks is generally shown at 50. The peer device 50 may include additional components, such as various interfaces to communicate with other devices, and further input and output devices to interact with an administrator with access to the peer device 50. In the present example, the peer device 50 may be a similar device to the apparatus 10 and that the two may reverse roles depending on where an issue is detected. The peer device 50 includes a memory storage unit 55, an administration engine 60, a communications interface 65, and an authentication engine 70, a diagnostic engine 75, and a repair engine 80. Although the present example shows the administration engine 60, the authentication engine 70, the diagnostic engine 75, and the repair engine 80 as separate components, in other examples, the administration engine 60, the authentication engine 70, the diagnostic engine 75, and the repair engine 80 may be part of the same physical component such as a microprocessor configured to carry out multiple functions, or be combined in a plurality of microprocessors.

The memory storage unit 55 is to store a peer set of troubleshooting solutions. The manner by which the memory storage unit 55 stores the peer set of troubleshooting solutions is not particularly limited. In the present example, the memory storage unit 55 may function similarly to the memory storage unit 15 of the apparatus 10. Similarly, the memory storage unit 55 may include a non-transitory machine-readable storage medium that may be, for example, an electronic, magnetic, optical, or other physical storage device. In the present example, the memory storage unit 55 is a persistent memory for storing the peer set of troubleshooting solutions. In addition, the memory storage unit 55 may include an operating system that is executable by a processor to provide general functionality to the peer device 50. For example, the operating system may provide functionality to additional applications. Examples of operating systems include Windows™, macOS™, iOS™, Android™, Linux™, and Unix™. The memory storage unit 55 may additionally store instructions to operate at the driver level as well as other hardware drivers to communicate with other components and peripheral devices of the peer device 50.

The administration engine 60 is to communicate with a network to manage a subscription service. In the present example, the subscription service may be for a device as a service, where the administration engine 60 is to manage aspects of the subscription service based on a role of the apparatus. In the present example, the administration engine 60 functions similarly in the peer device 50 as the administration engine 20 functions in the apparatus 10.

The communications interface 65 is to communicate with other devices on the same network as well as the apparatus 10 connected to a separate network. The manner by which the communications interface 65 receives and sends data is not particularly limited. In the present example, the communications interface 65 performs similar functions in the peer device 50 as the communications interface 15 performs in the apparatus 10. The data exchanged is not particularly limited. For example, the data may include receiving a query for a solution to an issue from the apparatus and transmitting a solution for troubleshooting in response to the query.

The authentication engine 70 is to authenticate the apparatus 10 to establish a link with the peer-to-peer link. In the present example, the authentication engine 70 is to authenticate the device on the external network so that troubleshooting solutions are provided to partner networks instead of to an unknown network or a competitor network.

The diagnostic engine 75 is to carry out a diagnostic process on the peer device 50. In the present example, the diagnostic engine 75 may perform similar functions in the peer device 50 as the diagnostic engine 35 performs in the apparatus 10. For example, the diagnostic engine 75 is to collect diagnostic data using the diagnostic process on various components of the peer device 50, such as the memory storage unit 55 and/or a processor, to identify a potential issue. It is to be appreciated that the diagnostic engine 75 operates in the background on the peer device 50.

In the present example, the diagnostic engine 75 is to collect diagnostic data from a processor and the memory storage unit 55 of the peer device 50. The diagnostic engine 75 operates as a background process during normal operation of the peer device 50 to identify and address potential issues that may occur. The background process may use a small amount of processor resources such that the background process does not substantially affect foreground processes running on the peer device 50, such as searching for solutions.

The repair engine 80 is to implement the solution selected by the diagnostic engine 75. The manner by which the repair engine 80 implements the solution is not particularly limited an may depend on the issue/solution identified by the diagnostic engine 75. It is to be appreciated that the repair engine 80.

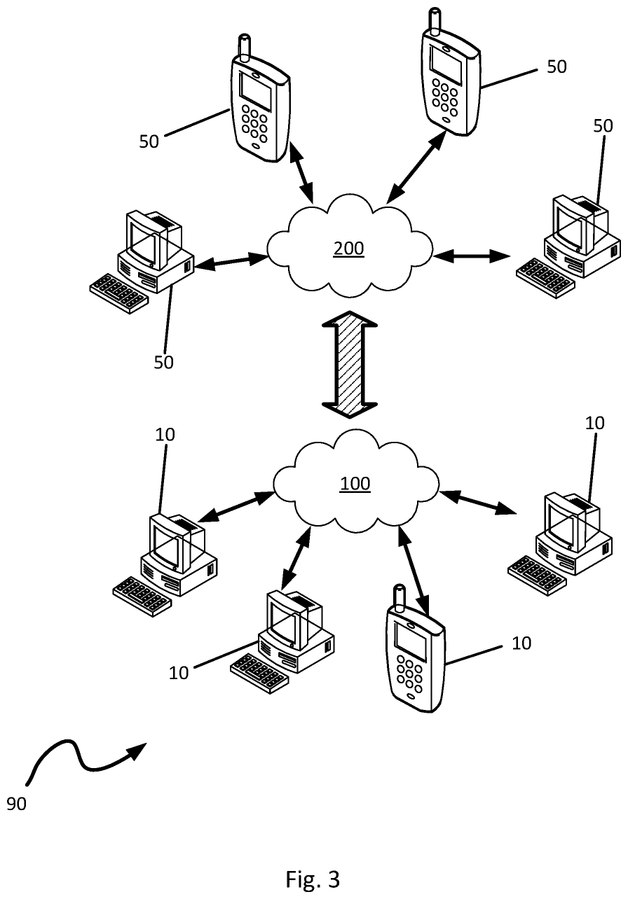

Referring to FIG. 3, an example of a system to monitor devices for overall performance generally shown at 90. In the present example, the apparatus 10 is in communication with a plurality of devices 50 via a network 100. Similarly, the peer device 50 is in communication with a plurality of devices 50 via a network 200 separate from the network 100. In this example, the network 100 and the network 200 are partner networks for sharing issue/solution pairs. The apparatus 10 of the network 100 generally does not communicate with peer devices 50 of the network 200 regarding any other matters.

It is to be appreciated that the apparatus 10 are not limited and may be a variety of apparatus 10 on the network. For example, the apparatus 10 may be a personal computer, a tablet computing device, a smart phone, or laptop computer. In the present example, the apparatus 10 may each run a plurality of applications. Similarly, it is to be appreciated that the peer devices 50 are not limited and may be a variety of peer devices 50 on the network. In the present example, the peer device 50 may each run a plurality of applications. Although five apparatus 10 and five peer devices 50 are illustrated in FIG. 3, it is to be appreciated that the system 90 may include more apparatus 10 and/or devices 50. For example, the system 80 may include hundreds or thousands of apparatus 10 and peer devices 50.

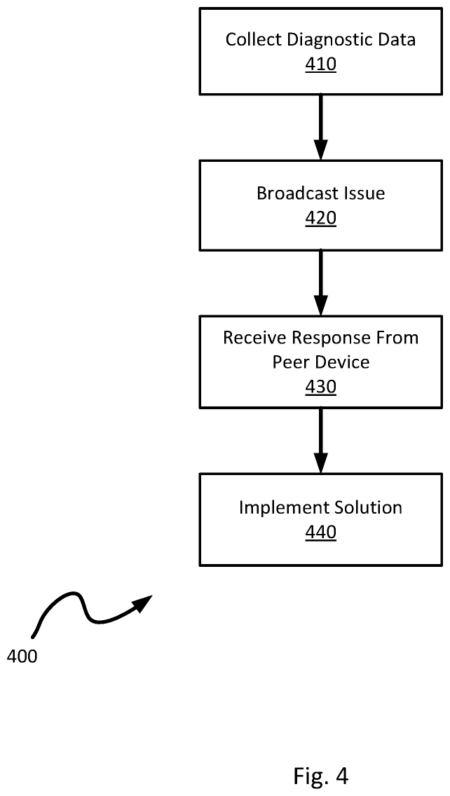

Referring to FIG. 4, a flowchart of an example method of carrying out automatic repairs using communications with peer devices across multiple networks is generally shown at 400. In order to assist in the explanation of method 400, it will be assumed that method 400 may be performed by the system 90. Indeed, the method 400 may be one way in which the system 90 may be configured. Furthermore, the following discussion of method 400 may lead to a further understanding of the apparatus 10 and the peer device 50. In addition, it is to be emphasized, that method 400 may not be performed in the exact sequence as shown, and various blocks may be performed in parallel rather than in sequence, or in a different sequence altogether.

Beginning at block 410, diagnostic data is collected using the diagnostic engine 35. The diagnostic data is then used by the diagnostic engine 35 to identify an issue at the apparatus 10. The manner by which the diagnostic data is collected is not limited. For example, the diagnostic engine 35 may collect diagnostic data from a processor and the memory storage unit 15 of the apparatus 10 using a background process. In addition, diagnostic data may be continuously or periodically collected. Therefore, once an issue is determined based on the diagnostic data, corrective measures may be taken prior to a failure of the entire apparatus 10.

Block 420 involves broadcasting the issue identified at block 410 to a plurality of peer devices 50 via the communications interface 25. In the present example, the apparatus 10 at which an issue is identified may broadcast a description of the issue, such as a standardized error code. In other examples, the error may be in the form of an error report. Accordingly, if the apparatus 10 experiences a driver failure for a peripheral device, such as a printer, the apparatus may broadcast an error code to the peer devices 50 on the network 200.

In some examples, prior to broadcasting the error code to the network 200, an authentication step may be carried out to ensure that the network 200 is a partner network of the network 100. The authentication process is not particularly limited. For example, the authentication process may involve authenticating each device or authenticating the network 200 and that different peer devices 50 on the network 200 may have different consent levels. The determination consent levels of the peer devices 50 is not particular limited. For example, the consent levels may be determined and changed over time, such as if the consent level was based on the role of the specific peer device on the network 200. In other examples, the consent level of each device may be determined prior to the deployment of the peer device 50 such that it may not be changed at a later time.

Block 430 involves receiving a response from a peer device 50. In the present example, the apparatus 10 may receive a response from a peer device 50 that is capable of addressing the issue broadcasted at block 420. In other examples, the apparatus 10 may receive a response from each of the peer devices 50 connected to the network 200. The response from the peer device 50 may include a solution from the set of troubleshooting solutions stored in the memory storage unit 55. In other examples, the peer device 50 may further search additional peer devices on other networks. For example, the peer device 50 may communicate with an additional network that is not partnered with the network 100. Accordingly, the peer device 50 may function as a proxy device to increase the amount of troubleshooting solutions available to the apparatus 10.

At block 440, a solution based on the response receive at block 430 is implemented on the apparatus 10. The manner by which the solution is implemented is not particularly limited an may depend on the original issue and/or the solution based on the response. In some examples, the issue/solution may be classified into different types of issue/solution pairs. For example, the issue/solution may be generally classified as a hardware issue or a software issue in this example. It is to be appreciated that in other examples, issues may be classified into more categories.

Continuing with this example, when an issue is classified as a hardware issue, the solution to be implemented may be to generate a message on a display for a user to take action to replace a hardware component. In another example, a message may be automatically transmitted to an administrator of a device as a service subscription to generate a trouble ticket automatically.

If the issue is classified as the issue as a software issue, the solution may involve initiating a process to correct the software issue automatically without administrator or human intervention. For example, the software issue may be identified by in the response received at block 430 to be a bad driver that is to be updated. In this case, the repair engine 35 may automatically select the correct driver based on the response and execute an update to install the new driver automatically. As another example, the issue may involve a software update that causes unexpected compatibility issues with the existing hardware or software of the apparatus 10. In this case, the response received at block 430 may roll back the update.

It is to be appreciated that in some examples, the repair engine 40 may also evaluate the success of the implemented solution based on responses from external computers, such as the response received at block 430 from the peer device 50. The manner by which success is measured is not limited. For example, the same data collected by the diagnostic engine 35 may be evaluated to determine if the issue has been resolved. In some examples, a successful solution received from the peer device 50 may be added to the local set of troubleshooting solutions on the memory storage unit 15 to make the solution locally available in the future to the apparatus 10 or to other devices that query the apparatus 10.

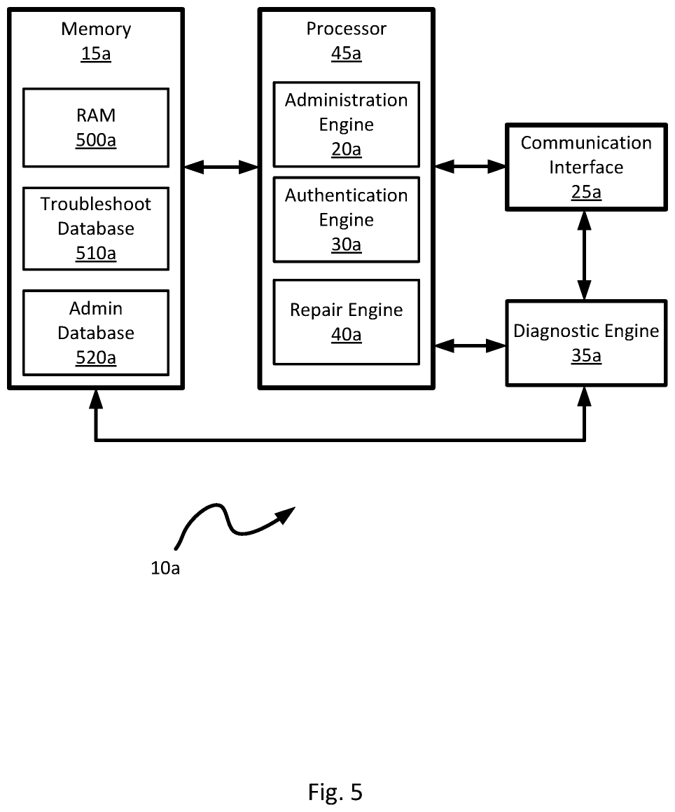

Referring to FIG. 5, another example of an apparatus to carry out automatic repairs using communications with peer devices across multiple networks is generally shown at 10a. Like components of the apparatus 10a bear like reference to their counterparts in the apparatus 10, except followed by the suffix “a”. The apparatus 10a includes a memory storage unit 15a, an administration engine 20a, a communications interface 25a, and an authentication engine 30a, a diagnostic engine 35a, and a repair engine 40a. In the present example, the administration engine 20a, the authentication engine 30a, and the repair engine 40a are implemented by a processor 45a. Although the present example shows the processor 35a operating various components, in other examples, multiple processors may also be used. The processors may also be virtual machines in the cloud that may actually be a different physical machine with each implementation of the administration engine 20a, the authentication engine 30a, and the repair engine 40a. Since the diagnostic engine 35a is to monitor the processor 45a, the present example shows the diagnostic engine 35a remaining separate from the processor 45a.

The processor 45a may include a central processing unit (CPU), a graphics processing unit (GPU), a microcontroller, a microprocessor, a processing core, a field-programmable gate array (FPGA), an application-specific integrated circuit (ASIC), or similar. The processor 45a and the memory storage unit 15a may cooperate to execute various instructions. The processor 45a may execute instructions encoded on the memory storage unit 15a to carry out processes such as the method 400. In other examples, the processor 45a may execute instructions stored on the memory storage unit 15a to implement the administration engine 20a, the authentication engine 30a, and the repair engine 40a. In other examples, the administration engine 20a, the authentication engine 30a, and the repair engine 40a may each be executed on a separate processor. In further examples, the administration engine 20a, the authentication engine 30a, and the repair engine 40a may be operated on a separate machine, such as from a software as a service provider or in a virtual cloud server as mentioned above.

Furthermore, in the present example, the memory storage unit 15a includes a portion dedicated to provide a random access memory 500a for the apparatus 10 to utilize during normal operations. In addition, the memory storage unit 15a also includes the local set of troubleshooting solutions stored in a database 510a. The database 510a is not particularly limited. In the present examples, the database 510a may be a simple spreadsheet having two columns, one for the description of the issue and another for the solution. In other examples, more complicated database structures may be used to facilitate searching for specific issue/solution pairs.

In the present example the memory storage unit 15a further includes and administrator database 520a. The administrator database 520a is to store information related to the operation of the network 100 to which the apparatus is connected. For example, the database 520a may include data showing the roles of each type of device.

It should be recognized that features and aspects of the various examples provided above may be combined into further examples that also fall within the scope of the present disclosure.

What is claimed is:

1. An apparatus comprising:
a memory storage unit to store a local set of troubleshooting solutions;
an administration engine to communicate with a first network, wherein the administration engine is to manage a service subscription;
a communication interface to communicate with a peer device, wherein the peer device is part of a second network separate from the first network;
an authentication engine to authenticate the peer device to establish a link with the peer device to access a peer set of troubleshooting solutions;
a diagnostic engine to collect diagnostic data to identify an issue, wherein the diagnostic engine selects a solution from the local set of troubleshooting solutions and the peer set of troubleshooting solutions based on the diagnostic data; and
a repair engine to implement the solution.

2. The apparatus of claim 1, wherein the diagnostic engine classifies the issue as a hardware failure, and wherein the repair engine generates a message to notify a user about the hardware failure.

3. The apparatus of claim 1, wherein the diagnostic engine classifies the issue as a software failure, the diagnostic engine identifies an error associated with a driver.

4. The apparatus of claim 3, wherein the repair engine implements the solution with an automatic installation of the driver.

5. The apparatus of claim 1, wherein the repair engine adds the solution to the local set of troubleshooting solutions when the solution is obtained from the peer set of troubleshooting solutions.

6. The apparatus of claim 1, wherein the link is a peer-to-peer link.

7. The apparatus of claim 1, wherein the first network and the second network are part of a distributed set of networks to share information.

8. A method comprising:
collecting diagnostic data with a diagnostic engine to identify an issue;
broadcasting the issue identified by the diagnostic engine, via a communication interface connected to a first network, to a plurality of peer devices;
receiving a response from a peer device of the plurality of peer devices, wherein the peer device is connected to a second network; and
implementing a solution based on the response.

9. The method of claim 8, further comprising authenticating the peer device based on a consent level between the first network and the second network.

10. The method of claim 8, further comprising classifying the issue as a hardware failure, and wherein implementing the solution comprises generating a message to notify a user about the hardware failure.

11. The method of claim 8, further comprising classifying the issue as a software failure, and wherein selecting the solution comprises selecting a driver.

12. The method of claim 11, wherein implementing the solution comprises automatically installing the driver.

13. The method of claim 8, further comprising adding the solution to a local set of troubleshooting solutions.

14. A non-transitory machine-readable storage medium encoded with instructions executable by a processor, the non-transitory machine-readable storage medium comprising:
instructions to collect diagnostic data with a diagnostic engine to identify a software error;
instructions to broadcast the software error identified by the diagnostic engine to a plurality of peer devices;
instructions to receive a response from a peer device of the plurality of peer devices, wherein the peer device is connected to a second network; and
instructions to implement a solution based on the response.

15. The non-transitory machine-readable storage medium of claim 14, further comprising instructions to add the solution to a local set of troubleshooting solutions.
